(19) United States
(12) Patent Application Publication
(10) Pub. No.: US 2025/0312853 A1
(43) Pub. Date: Oct. 9, 2025

(54) Method for Controlling Introduction of Different Kinds of Materials for Lamination and System Therefor

(71) Applicant: AMSOLUTIONS INC., Yuseong-gu, Daejeon (KR)

(72) Inventor: Daejung Kim, Daejeon (KR)

(21) Appl. No.: 18/861,140

(22) PCT Filed: Apr. 12, 2023
(86) PCT No.: PCT/KR2023/004957

§ 371 Date: Jun. 30, 2025

(30) Foreign Application Priority Data
Apr. 29, 2022 (KR) 10-2022-0053507

(51) Int. Cl. B22F 10/85; B22F 10/25; B22F 12/58; B33Y 50/02

(52) U.S. Cl. CPC B22F 10/85; B22F 10/25; B22F 12/58; B33Y 50/02

(57) ABSTRACT

A method for controlling introduction of different kinds of materials for lamination includes: a tool path generating step of slicing three-dimensional image data into multiple slices and determining a nozzle movement path; a sensitivity applying step of deriving the sensitivity of different kinds of materials with regard to an objective function through numerical analysis and applying same to the three-dimensional image data or tool path; and a lamination control step of supplying, mixing, and laminating different kinds of materials. The sensitivity applying step includes: an objective function designating step of determining an objective function according to the target of optimization of physical characteristics held by the shape of three-dimensional image data; a numerical analysis step of deriving the sensitivity regarding materials by performing numerical analysis according to the objective function; and a mapping step of mapping the sensitivity regarding materials to the three-dimensional image data or tool path.

### TECHNICAL FIELD

The present disclosure relates to a method for controlling the input of heterogeneous materials in additive manufacturing, more particularly, a toolpath creating step which slices provided 3D image data into multiple slices and determines nozzle's movement path, a sensitivity applying step which derives the sensitivity of heterogeneous materials to the objective function through numerical analysis and applies it to the 3Dimage data or the toolpath, and a stacking control step which supplies and mixes heterogeneous materials and stacks, wherein a sensitivity applying step includes an objective function designating step which determines objective function according to optimization goal of physical property of shape of 3D image data, a numerical analyzing step which derives sensitivity of material by performing numerical analysis according to the objective function, and a mapping step which maps sensitivity of material to the 3D image data or toolpath, thereby create a toolpath mapping numerical analysis result and change input material in real-time according to numerical analysis result through database, etc of physical properties of material used for additive manufacturing, thereby enabling real-time change of supplying material that was conventionally divided into layers. This invention provides a heterogeneous material input control method for additive manufacturing that can exclude process defects for product to be additively manufactured by 3D printer and materialize targeted physical properties with minimal error.

### BACKGROUND ART

3D printer reduces design makes it easier to manufacture objects than manufacturing such as casting by producing real figures using 3D computer-aided design (CAD, etc.), and metal additive manufacturing technology such as that shown in FIG. 1, is a technology that uses metal powder and metal wire to add 3D shapes, compared to 3D printing technology that uses conventional polymer materials. Conventional metal additive manufacturing is carried out by creating layer based on toolpath in CAM S/W and applying process parameters such as input materials and heat source settings, and technology has evolved to apply different physical properties and process parameters for each layer.

However, since process parameters set in the above technology are the same for each layer, it is not possible to avoid the occurrence of process defects due to the complexity of shape, environmental variables, etc. on one layer, and it is necessary to equip various toolpaths to impart physical properties through imputing various materials. In particular, when performing metal additive manufacturing using various materials to achieve desired physical properties, it is not possible to effectively change the composition of material according to desired physical properties such as thermal conductivity and strength, etc. because object has complex shape or is exposed to heat source during operating environment, and composition of material is added in a constant state in one slicing or layer, even though using one material in certain areas and another material in other areas, or mixing different materials for performing metal additive manufacturing.

### DISCLOSURE

### Technical Problem

Accordingly, the present disclosure has been made keeping in mind the above problems occurring in the related art.

An objective of the present disclosure is to provide a heterogeneous material input control system of additive manufacturing, wherein the present disclosure includes a toolpath generating step by slicing provided 3D image data into multiple slices and determining nozzle's movement path, a sensitivity deriving step deriving sensitivity of heterogeneous materials to objective function through numerical analysis and applying sensitivity to the 3D image data or the toolpath, and a stacking control step by supplying, mixing, and stacking heterogeneous material, wherein a sensitivity applying step includes objective function designating step to determine objective function according to a goal of optimizing physical properties of shape of 3D image data, a numerical analysis step to derive sensitivity of material by performing numerical analysis according to the objective function, and a mapping step to map sensitivity of material to the 3D image data or toolpath to generate a toolpath mapping numerical analysis result, and change input materials real-time according to numerical analysis result, thereby providing a heterogeneous material input control method for additive manufacturing that enables real-time change of input materials which have been conventionally divided by layers, thereby eliminating process defects and materializing targeted physical properties with minimal error for products which are additively manufactured by 3D printers.

An objective of the present disclosure is to provide a heterogeneous material input control system of additive manufacturing, wherein the sensitivity applying step includes an objective function designating step for determining an objective function according to an optimization goal of physical property of a shape of 3D image data, a numerical analysis step for performing numerical analysis according to the objective function to derive sensitivity of material, and a mapping step for mapping sensitivity of material to the 3D image data or toolpath, so that sensitivity of material can be mapped to a single toolpath and heterogeneous materials can be mixed and additively manufactured with a single toolpath during additive manufacturing.

An object of the present disclosure to provide a method for controlling input of heterogeneous materials in additive manufacturing wherein mixing ratio of heterogeneous materials in a single toolpath can be changed according to sensitivity by mapping sensitivity defined for each coordinate to the 3D image data or spot of toolpath corresponding to the coordinates in the mapping step.

An object of the present disclosure is to provide a method for controlling input of heterogeneous materials in additive manufacturing, wherein the sensitivity applying step further comprises a step of determining a transition region to determine a region having a sensitivity which causes heterogeneous materials to be used among sensitivities derived from numerical analysis, and the mapping step provides method of controlling input of heterogeneous materials in additive manufacturing which can reduce amount of resource used for analyzing toolpath and supplying resource.

An object of the present invention is to provide a heterogeneous material input control method for additive manufacturing in which amount of material input is controlled according to sensitivity by including a material supply step for supplying multiple materials, a supply amount control step for controlling amount of material input according to sensitivity applied to the 3D image data or toolpath, a mixing step for mixing multiple materials, and an additive manufacturing step for supplying and additively manufacturing materials in a 3D printer.

An object of the present disclosure is to provide heterogeneous material input control method for additive manufacturing, in which the supply amount control step specifies a predetermined range of sensitivity within 3D image data or toolpath where sensitivity is mapped, and causes the 3D printer to supply at least one first material at a sensitivity below predetermined range, at least one second material at a sensitivity above predetermined range, and a mixture of first and second materials in sensitivity region within predetermined range, but supplies first and second materials in different mixing ratios according to changes in sensitivity within predetermined range.

An object of the present disclosure is to provide a method for controlling input of heterogeneous materials in additive manufacturing, wherein the supply amount control step additionally supplies at least one third material to enable application of enhanced physical properties.

An object of the present disclosure is to provide a heterogeneous material input control method for additive manufacturing, wherein the stacking control step includes a smoothing step for smoothing sensitivity before the supply amount control step, and the smoothing step sets a supply change cycle in the supply amount control step, and calculates and smoothes sensitivity of a predetermined number of consecutive spots on toolpath according to supply change cycle to prevent excessive supply changes.

An object of the present disclosure is to provide a heterogeneous material input control system for additive manufacturing that enables real-time changes in the input materials that are conventionally divided into layers to eliminate process defects and realize targeted physical properties with minimal for error products that are additively manufactured by a 3D printer by including a 3D printer for performing additive manufacturing by spraying at least one material through a nozzle and heating it to deposit it to a surface, wherein the 3D printer includes a controller for receiving 3D image data and controlling a supply of at least one material provided through the 3D printer, wherein the 3D printer comprises at least one material supply unit for storing and supplying powder to be sprayed for additive manufacturing, a mixing unit for mixing the material supplied from the material supply unit, a nozzle coupled to one side of the 3D printer for dispensing the mixed material onto surface, and a heating unit for heating material sprayed onto surface through the nozzle to form it into a molten state, the controller includes a toolpath generating unit for slicing the provided three-dimensional image data into multiple slices and determining a nozzle movement path, a numerical analysis part for deriving the sensitivity of the heterogeneous material to the objective function through numerical analysis and applying it to the three-dimensional image data or the toolpath, and a supply control part for controlling the supply rate and supply amount of the material in the 3D printer through powder supply instructions, while the supply control unit controls the amount of supply material to mix the heterogeneous materials according to sensitivity of heterogeneous materials to objective function mapped to toolpath, thereby changing input material in real-time according to numerical analysis result.

An object of the present disclosure is to provide a heterogeneous material input control system for additive manufacturing, wherein the supply control part specifies a predetermined range of sensitivity in the 3D image data or toolpath in which sensitivity is mapped, and causes the 3D printer to supply at least one first material at a sensitivity below predetermined range, at least one second material at a sensitivity above predetermined range, and a mixture of first and second materials in sensitivity region within predetermined range, thereby varying materials according to properties to be obtained and mixing materials by region in the region where properties vary depending on materials.

An object of the present disclosure is to provide a heterogeneous material input control system for additive manufacturing that prevents excessive changes in material supply by setting a change cycle of material supply from material supply part of the 3D printer, calculating and smoothing sensitivity of a predetermined number of consecutive spots on toolpath according to change cycle of material supply, and then controlling amount of material supplied.

### Technical Solution

The present disclosure may be implemented by one or more embodiments having some or all of the following configurations.

According to one embodiment of the present disclosure, the present disclosure comprises a toolpath generating step that slices provided 3D image data into multiple slices and determines a nozzle movement path, a sensitivity applying step that derives a sensitivity of the heterogeneous material to an objective function through numerical analysis and applies the sensitivity to the 3D image data or toolpath, and a stacking control step that supplies, mixes, and stacks heterogeneous materials.

According to one embodiment of the present disclosure, the sensitivity applying step comprises an objective function designating step for determining an objective function according to an optimization goal of physical property of shape of 3D image data, a numerical analysis step for performing numerical analysis according to the objective function to derive sensitivity of material, and a mapping step for mapping sensitivity of material to the 3D image data or toolpath.

According to one embodiment of the present disclosure, the mapping step is characterized by mapping sensitivity defined by coordinates to spots in the 3D image data or toolpath corresponding to the coordinates.

According to one embodiment of the present disclosure, the mapping step is characterized by storing at least one material mixing ratio in the spots according to mapped sensitivity.

According to one embodiment of the present disclosure, the sensitivity applying step further comprises a transition region determining step to determine a region having a sensitivity to use the heterogeneous materials among sensitivities derived from numerical analysis, and the mapping step is characterized in that sensitivity within transition region is mapped.

According to one embodiment of the present disclosure, the stacking control step is characterized in that it comprises a material supply step for supplying multiple materials, a supply amount control step for controlling supply of materials based on sensitivity applied to the 3D image data or toolpath, a mixing step for mixing multiple materials, and an additive manufacturing step for supplying and additively manufacturing materials in 3D printer.

According to one embodiment of the present disclosure, the supply amount control step is characterized by specifying a predetermined range of sensitivities within the 3D image data or toolpath with mapped sensitivities, and causing the 3D printer to supply at least one first material at sensitivities below predetermined range, at least one second material at sensitivities above predetermined range, and a mixture of first and second materials at sensitivity regions within predetermined range.

According to one embodiment of the present disclosure, the supply amount control step is characterized in that first material and second material are supplied in different mixing ratios according to changes in sensitivity within predetermined range.

According to one embodiment of the present disclosure, the supply amount control step further supplies at least one third material, characterized in that the third material has physical property between physical properties of first material and second material that affect objective function.

According to one embodiment of the present disclosure, the stacking control step comprises a smoothing step for smoothing sensitivity prior to the supply amount control step, and the smoothing step being characterized in that the smoothing step sets up supply change cycle in the supply amount control step, and computing and smoothing sensitivity of a predetermined number of consecutive spots on toolpath according to supply change cycle.

According to one embodiment of the present disclosure, the material supplying step is characterized in that multiple materials are supplied as powder phase, and the mixing step is characterized in that powders are mixed through an airflow formed inside the 3D printer.

According to one embodiment of the present disclosure, it comprises a 3D printer for performing additive manufacturing by spraying at least one material through a nozzle and then heating it to melt and deposit it on a surface, and a controller that receives 3D image data and controls supply of at least one material provided through the 3D printer, wherein the 3D printer comprises at least one material supply portion for storing and supplying powder to be sprayed for additive manufacturing, a mixing part for mixing material supplied from the material supply part, a nozzle coupled to one side of the 3D printer to discharge mixed material onto a surface, and a heating part for heating the material sprayed onto surface through nozzle to form a molten state, while the controller comprises a toolpath generating part for slicing provided 3D image data into multiple slices and determining a movement path of nozzle, a numerical analysis part for deriving a sensitivity of the heterogeneous material to an objective function through numerical analysis and applying it to said three-dimensional image data or toolpath, and a supply control part for controlling supplying speed and supplying amount of a material in the 3D printer through a powder supplying command, wherein the supply control part controls the supplying amount of material to mix heterogeneous material according to sensitivity of heterogeneous material to objective function mapped in toolpath.

According to one embodiment of the present disclosure, the supply control part is characterized in that it specifies a predetermined range of sensitivities within the 3D image data or toolpath with mapped sensitivities, and causes the 3D printer to supply at least one first material at sensitivities below the predetermined range, at least one second material at sensitivities above predetermined range, and a mixture of first and second materials at sensitivity regions within predetermined range.

According to one embodiment of the present disclosure, the supply control part is characterized in that it sets a supply change cycle of material supplied from material supply part of the 3D printer, calculates and smoothes sensitivity of a predetermined number of consecutive spots on toolpath according to supply change cycle, and then controls supply of material.

### Advantageous Effects

The present disclosure may achieve the follow effects from the embodiment and configurations described below, as well as combinations and relationships of use thereof.

According to the present disclosure, the present disclosure comprises a toolpath generating step that slices provided 3D image data into multiple slices and determines a movement path of a nozzle, a sensitivity applying step that derives sensitivity of heterogeneous material to objective function through numerical analysis and applies sensitivity to 3D image data or toolpath, a stacking control step that supplies and mixes heterogeneous materials and adds them, wherein a sensitivity applying step comprises an objective function designating step that determines objective function according to optimization goal of physical property of shape of 3D image data, a numerical analysis step that derives sensitivity of material by performing numerical analysis according to the objective function, and a mapping step that maps sensitivity of material to the 3D image data or toolpath to generate toolpath that maps result of numerical analysis and changes input material in real-time according to result of numerical analysis through database of physical properties of material used for additive manufacturing, thereby enabling real-time change of input material that was conventionally divided into layers, to provide a heterogeneous material input control method additive of manufacturing that enables materialization of targeted physical properties with minimal error while excluding process defects for product to be additively manufactured with a 3D printer.

According to the present disclosure, the sensitivity applying step includes objective function designating step determining objective function according to objectives of optimizing physical properties of shape of 3D image data, a numerical analysis step deriving sensitivity to material by performing numerical analysis according to objective function, and mapping step mapping sensitivity of material to 3D image data or toolpath, so that sensitivity of material can be mapped to a single toolpath to enable additive manufacturing by mixing heterogeneous materials with a single toolpath.

According to the present disclosure, the mapping step has an effect of mapping sensitivities defined by coordinates to spots in the 3D image data or toolpath corresponding to the coordinates, so that mixing ratio of heterogeneous materials in a single toolpath can be changed to match sensitivity.

According to the present disclosure, the sensitivity applying step further comprises a transition region determining step determining a region having sensitivity of numerical analysis to use heterogeneous materials, wherein the mapping step may reduce amount of resources used for toolpath analysis and material supply by mapping sensitivity within transition region.

According to the present disclosure, the stacking control step includes material supply step of supplying multiple materials, supply amount control step of controlling supply amount of materials according to sensitivity applied to the 3D image data or toolpath, mixing step of mixing multiple materials, and stacking step of supplying and adding materials from 3D printer to control amount of materials supplied according to sensitivity.

According to the present disclosure, the supply amount control step specifies a predetermined range of sensitivity within the 3D image data or toolpath to which sensitivity is mapped, and causes the 3D printer to supply at least one first material at a sensitivity below predetermined range, at least one second material at a sensitivity above predetermined range, and a mixture of first and second materials in sensitivity region within predetermined range, but may supply first and second materials in different mixing ratios depending on change in sensitivity within predetermined range.

According to the present disclosure, the supply amount control step has an effect of further supplying at least one third material to enable application of enhanced physical property.

According to the present disclosure, the stacking control step includes a smoothing step for smoothing sensitivity before supply amount control step, wherein the smoothing step sets a supply amount change cycle in the supply amount control step, and calculates and smoothes sensitivity of a predetermined number of consecutive spots on toolpath according to the supply amount change cycle to provide a heterogeneous material input control method for additive manufacturing for preventing excessive supply amount changes.

According to the present disclosure, a heterogeneous material input control method for additive manufacturing comprises a 3D printer performing additive manufacturing by spraying at least one material through nozzle and then heating and welding material to a surface, and a controller receiving 3D image data and controlling amount of at least one material supply provided through the 3D printer, wherein the 3D printer comprises at least one material supply part storing and supplying powder to be sprayed for additive manufacturing, a mixing part mixing materials supplied from the material supply part, a nozzle coupled to one side of the 3D printer for dispensing mixed material on surface, and a heating part heating material dispensed onto surface through nozzle to form a molten state, wherein the controller comprises a toolpath generating part slicing provided 3D image data into multiple slices and determining movement path of nozzle, a numerical analysis part deriving sensitivity of heterogeneous material to objective function through numerical analysis and applying it to the 3D image data of toolpath, and a supply control part controlling supply speed and amount of material in the 3D printer through powder supply command, while the supply control part controls supply of heterogeneous materials to be mixed according to sensitivity of heterogeneous materials to objective function mapped to toolpath to change input materials real-time according to numerical analysis result, thereby enabling real-time change of supplying material that was conventionally divided into layers, thereby providing a heterogeneous material input control method for additive manufacturing that can exclude process defects for product to be additively manufactured by 3D printer and materialize targeted physical properties with minimal error.

According to the present disclosure, the supply control part designates a predetermined range of sensitivity within the 3D image data or toolpath to which the sensitivity is mapped, and causing the 3D printer to supply at least one first material at a sensitivity below predetermined range, at least one second material at a sensitivity above predetermined range, and a mixture of first and second materials in the sensitivity region within predetermined range, thereby varying materials according to physical properties to be obtained and mixing and adding materials by region in region where physical properties vary depending on materials.

According to the present disclosure, the supply control part sets supply change cycle of material supplied from material supply part of the 3D printer, calculates and smoothes sensitivity of a predetermined number of spots on toolpath according to supply change cycle, and then controls supply amount of material to prevent excessive changes in supply amount.

### DESCRIPTION OF DRAWINGS

FIG. 1 is a conceptual diagram of additive manufacturing according to conventional technology.

FIG. 2 is a flowchart of a heterogeneous material input control method for additive manufacturing according to an embodiment of the present disclosure.

FIG. 3 is a block diagram of a controller 10 and a 3D printer 20 for carrying out the present disclosure.

FIG. 4 is a diagram illustrating a toolpath generation in toolpath generation part 13 of the present disclosure.

FIG. 5 is a conceptual diagram of a 3D printer of the present disclosure.

FIG. 6 is a flowchart of sensitivity applying step S50 according to an embodiment of the present disclosure.

FIG. 7 is a diagram showing sensitivity distribution derived through numerical analysis.

FIG. 8 is a diagram showing that sensitivity is matched to toolpath.

FIG. 9 is an enlarged view of part R of FIG. 8.

FIG. 10 is a flowchart of the stacking control step S70 according to an embodiment of the present disclosure.

FIG. 11 is a diagram illustrating various embodiments of the mixed heterogeneous material according to mixing step S77 of the present disclosure.

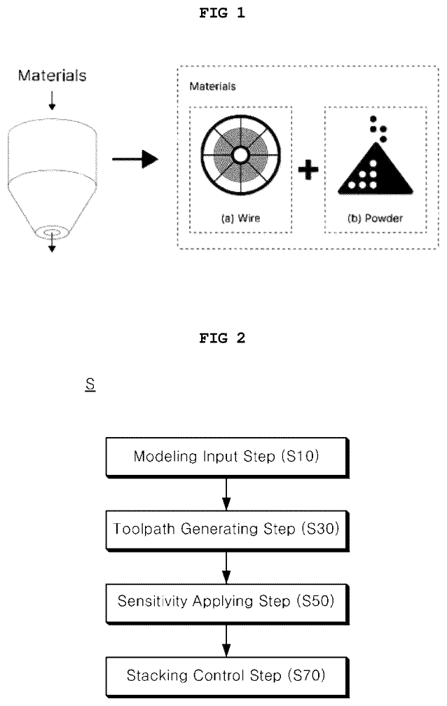

### MODE FOR INVENTION

Hereinafter, a heterogeneous material input control method for additive manufacturing according to the present disclosure will be described in detail with reference to the accompanying drawings. It should be noted that identical components in drawings are denoted by same symbols wherever possible. In addition, detailed descriptions of known features and configurations that may unnecessarily obscure essentials of the present disclosure are omitted. Unless otherwise defined, all terms used herein have ordinary meaning as understood by a person having ordinary skill in the art to which the invention belongs, and in case of conflict with the meaning of a term used herein, the definition used herein shall apply. Collectively, whenever any part is said to “include” any component, it is not intended to exclude any other component, but is intended to include additional components, unless the contrary is specifically indicated, and terms such as “part” and the like herein are intended to mean a unit that performs at least one or more function or operation. Furthermore, when components are said to be “connected” to each other, this is not limited to direct contact between the components, but may include connection through other components, and may mean that the components are arranged to transmit certain force or energy even if they are not fastened. Terms such as “first”, “second”, and “third” may be used to designate identical or substantially identical configurations in different order, and may be interpreted as substantially the same as configurations not labeled “first”, “second”, and so on. Hereinafter, the present disclosure will be described in detail by describing preferred embodiments of the present disclosure with reference to accompanying drawings.

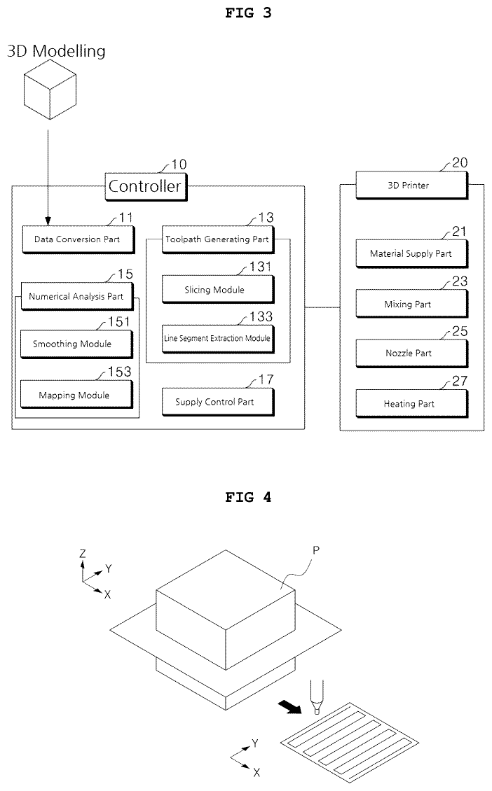

Referring to FIG. 2, heterogeneous material input control method S of additive manufacturing according to the present disclosure is characterized in that it generates a toolpath which is mapped numerical analysis result, and changes input material in real-time according to numerical analysis result through physical property database of material used for additive manufacturing to enable input material that was conventionally divided into layers to be changed in real-time, thereby excluding process defects and materializing targeted physical properties with minimal error for product that is additively manufactured by 3D printer. The heterogeneous material input control method for additive manufacturing S may be performed by 3D printer 20 and controller 10 as shown in FIG. 3, and may include a modeling input step S10, a toolpath generating step S30, a sensitivity applying step S50, and a stacking control step S70.

First, referring to FIG. 3, to describe main configuration of 3D printing device for implementing the present disclosure, the 3D printing device includes a 3D printer 20 and a controller 10.

The controller 10 is configured to manage and control the overall operation of 3D printer 20, forms a toolpath for producing a product corresponding to input 3D modeling data and 3D image data through additive process, and may control amount of multiple heterogeneous materials provided through 3D printer after deriving sensitivity of material of targeted physical property of product through numerical analysis. To this end, the controller 10 may be driven by at least one processor, and may include a data conversion part 11, a toolpath generation part 13, a numerical analysis part 15 and a supply control part 17.

The data conversion part 11 may be provided to convert input 3D image data into stereoscopic shaping data having a format such as STL. The converted stereoscopic shaping data includes information about vertices of each mesh, and information about surfaces formed by mesh.

The toolpath generating part 13 is configured to render a 3D model from stereoscopic shaping data and generate a toolpath, which is a path of movement of a nozzle during additive manufacturing. The toolpath generating part 13 includes a slicing module 131 and a line segment extraction module 133.

Referring to FIG. 4, the slicing module 131 slices rendered 3D modeling data, and 3D image data P into multiple planes, and the line segment extraction module 133 draws multiple line segments according to a predetermined algorithm in area where 3D image data P and each plane intersect to generate a toolpath, which is movement path of nozzle. In one embodiment of the present disclosure, as shown in FIG. 4, the toolpath may fill intersecting area in a zigzag direction, without excluding the possibility of filling the intersecting regions with other shapes, including concentric circle shapes, and so on from the scope of rights. The toolpath can adjust the size, porosity, and so on by adjusting gaps of the line segments filled along the intersecting area.

Referring back to FIG. 3, the numerical analysis part 15 is provided to perform numerical analysis according to objective function to derive sensitivity of material. The numerical analysis part 15 designates an objective function according to optimization goal of physical properties of shape of 3D image data, and performs numerical analysis according to predetermined objective function to derive sensitivity of material. As described later, sensitivity may be derived as a value from 0 to 1, but is not excluded from being derived as a range of other values, such as a value from 0 to 100, from the scope of the rights. As described later, sensitivity area derived from numerical analysis in the numerical analysis part 15 can be mapped with toolpath to control material supply differently for each area of toolpath. The numerical analysis part 15 may include a smoothing module 151 and a mapping module 153.

The smoothing module 151 may be provided to smooth sensitivities derived from numerical analysis process, and may calculate and smooth sensitivities of a predetermined number of consecutive spots on toolpath according to supply change cycle. In the present disclosure, different materials or mixing ratio are not used for each toolpath, but rather different sensitivities and mixing ratio are used for each spots of toolpath, i.e., coordinates of toolpath and/or 3D image data, and if supply is varied according to changing sensitivity and material mixing ratio, it is impossible to control or require too much control data depending on additive speed. Therefore, the smoothing module 151 can smooth sensitivity of a predetermined number of consecutive spots designated according to supply change cycle through methods such as average calculation, and control supply of heterogeneous materials according to smoothed mixing ratio and sensitivity.

The mapping module 153 may map sensitivity of material to the 3D image data or toolpath. The mapping module 153 may preferably map sensitivities defined for each coordinate to spots in the 3D image data or toolpath corresponding to coordinates. That is, for coordinate values of 3D image data or toolpaths, sensitivity at corresponding coordinate values can be applied.

The supply control part 17 is configured to control type, amount, speed, and so on of material supplied through nozzle in 3D printer 20, and material supply speed and supply amount are delivered in real-time through powder supply instruction from the supply control part 17, enabling input of multiple heterogeneous materials. The supply control part 17 may control amount of material to be supplied so that heterogeneous materials are mixed according to sensitivity of heterogeneous materials to objective function mapped in toolpath, and may specify a predetermined range of sensitivities within the 3D image data or toolpath where sensitivities are mapped, and may deliver a powder supply instruction to the 3D printer to supply at least one first material at a sensitivity below predetermined range, at least one second material at a sensitivity above predetermined range, and to supply a mixture of first material and second material in sensitivity region within predetermined range. Furthermore, the supply control part may set a supply amount change cycle of the material supplied from material supply part of the 3D printer, and control supply amount of material after smoothing by calculating sensitivity of a predetermined number of consecutive spots on toolpath according to supply amount change cycle, and process of supply control through the supply control part 17 will be described later in stacking control step S70.

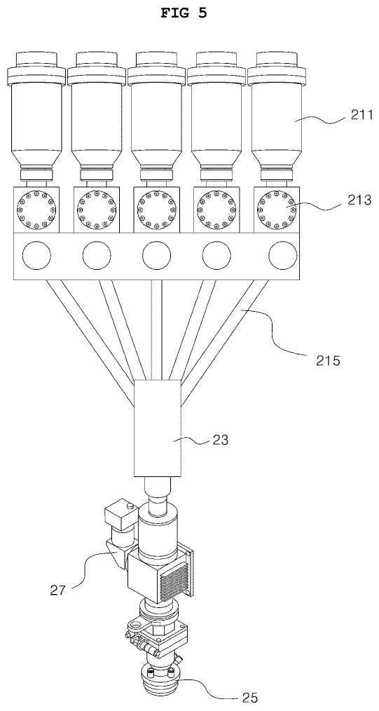

Referring to FIGS. 3 and 5, a 3D printer 20 for implementing the present disclosure is described, the 3D printer forms a product by additive manufacturing, preferably by spraying metal powder through nozzle and depositing it to a surface by heating means such as a laser. The 3D printer 20 is configured to supply multiple materials, mix them, and spray them through a nozzle, and includes a material supply part 21, a mixing part 23, a nozzle 25, and a heating part 27.

The material supply part 21 is a part for storing and supplying powder to be sprayed for additive manufacturing, and may be provided in plurality depending on the type of material, and in another embodiment of the present disclosure may be provided to supply ceramic powder, filament, and so on, instead of metal powder. In a preferred embodiment, the material supply part 211 may include a material storage part 211, a supply module 213, and a transfer pipe 215.

The material storage part 211 stores material for supply, and may comprise a container with a predetermined volume. It is preferable that a single material is stored in one material storage part 211.

The supply module 213 is configured to supply material stored in material storage part 211 to the mixing part 23 to be described later, and may be provided to adjust the speed at which material is supplied from the material storage part. The supply module 213 may regulate the amount and/or speed of material being exported from material storage part 211 by adjusting degree of opening and closing of material storage part 211 and rotational speed of motor, and may also regulate the amount and/or speed of material by adjusting vibration frequency when material is exported from material storage part 211. In other words, it is preferable that control of material supply through the supply module 213 is performed by control data from the supply control part 17 described above. The supply module 213 may be provided with a damper structure to control vibration generated during supply of metal powder material from material storage part 211.

The transfer pipe 215 is configured to convey material supplied from material storage part 211 to mixing part 23, wherein multiple transfer pipe 215 may extend from each material storage parts 211 and connect with mixing part 23.

The mixing part 23 is configured to mix material supplied from material supply part 211, and may be provided between material supply part 211 and nozzle 25. As will be described later, depending on sensitivity mapped on toolpath, at least one first material may be supplied or at least one second material may be supplied, and first and second materials may be mixed and then supplied, wherein the mixing part 23 may mix the materials and move them toward nozzle side. In an embodiment of the present disclosure, material supplied from material supply part 211 may have a metal powder phase, so that the mixing part 23 can form airflow inside to mix powder phase materials through smooth mixing. At this time, the airflow may be a flow of air formed through flow of process gas, and may also form an atmosphere inside mixing part for mixing each material.

The nozzle 25 is coupled to one side of 3D printer and is configured to discharge or spray material mixed in mixing part 23 onto a surface.

The heating part 27 may be configured to heat the material being sprayed onto surface through nozzle at one end of the nozzle 25 to bring it to a molten state. Molten material hardens as temperature decreases to form product. The heating portion 27 may heat the material by irradiating a laser, but may be any other configuration suitable for melting material on the surface.

Hereinafter, each step of a method for controlling the input of heterogeneous materials in additive manufacturing according to an embodiment of the present disclosure, performed through 3D printer 20 and controller 10, will be described.

Referring again to FIG. 2, the modeling input step S10 is a process in which 3D image data including 3D modeling is input, and may be performed in data conversion part 11 of the controller 10 described above. Modeling input step S10 may be provided with 3D image data externally, or may be provided with 3D image data internally generated by user's control. Modeling input step S10 can input 3D image data by converting it into stereoscopic data having a format such as STL.

The toolpath generating step S30 is a process of slicing provided 3D image data into multiple slices and determining a movement path of the nozzle, and may be performed in toolpath generation part 13, and may render the input three-dimensional image data into a three-dimensional object and then perform slicing into multiple planes. Furthermore, the toolpath generating step S30 may generate a toolpath, which is a movement path of nozzle, by drawing multiple line segments according to a predetermined algorithm for the area where 3D image data P and each plane intersect, and as shown in FIG. 4, may fill the area where the 3D image data P and each plane intersect in a zigzag direction or a concentric circle shape.

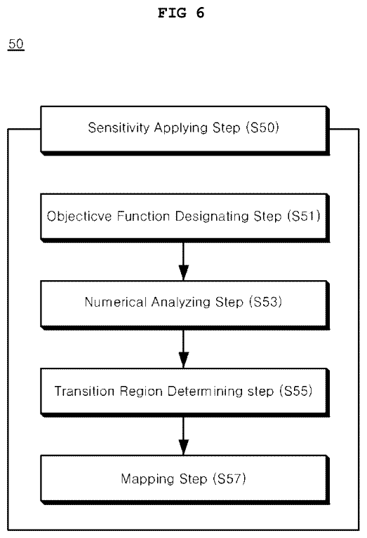

Referring to FIG. 6, the sensitivity applying step S50 is a process of deriving sensitivity of heterogeneous material to objective function through numerical analysis and applying it to the 3D image data or toolpath, which may be performed by numerical analysis part 15 of the controller 10. In sensitivity applying step S50, an objective function can be specified according to site-specific physical properties of product P that may vary depending on material, such as residual stress, site-specific strength, heat transfer coefficient, et cetera, and sensitivity to objective function derived through numerical analysis can be mapped to 3D image data or toolpath. While in an embodiment of the present disclosure may map the derived sensitivities to a toolpath generated after slicing, it is not excluded from the scope of the rights to generate a toolpath after mapping sensitivities to each spot in 3D image data before slicing. In other words, it is not necessary that the toolpath generating step S30 described above is performed prior to sensitivity applying step S50, and it can be understood that it is also within the scope of the rights of the present disclosure to generate a toolpath by slicing 3D image data to which sensitivity is mapped after performing sensitivity applying step S50. The sensitivity applying step S50 may include an objective function designating step S51, a numerical analysis step S53, a transition region determining step S55, and a mapping step S57.

The objective function designating step S51 is a process of determining an objective function according to an optimization goal of a physical property of shape of 3D image data, and objective function may be called up from a database or specified through a programmed algorithm according to selected goal. In an embodiment of the present disclosure, objective function may be set as an increase in strength of a predetermined region of the product, and a constraint such as specific gravity may be imposed to prevent excessive weight increase by the material. More than two objective functions may be designated depending on physical properties to be given to product, and multiple objective functions may be used.

The numerical analysis step S53 is a process of deriving sensitivity of material by performing numerical analysis according to a predetermined objective function, and in a preferred embodiment, sensitivity may be derived as a value from 0 to 1, but it is not excluded from the scope rights that sensitivity may be derived as a range of other values, such as a value from 0 to 100. The sensitivity can be understood to indicate how sensitively target property with the objective function can change with material, with low sensitivity indicating that properties of product are less related to material, and high sensitivity indicating that properties of additively manufactured part are more related to material.

The transition region determining step S55 is a process of determining a zone with a sensitivity to use a heterogeneous material among sensitivities derived from numerical analysis, wherein heterogeneous material means that first material and second material are mixed and supplied and then added. In an embodiment of the present invention, a region having a sensitivity value between 0 and 1 may be defined as a transition region, but in other embodiments, a region having a sensitivity value in a predetermined range, for example, 0.2 to 0.8, may be defined as a transition region, and range of sensitivity values may vary depending on objective function and algorithm.

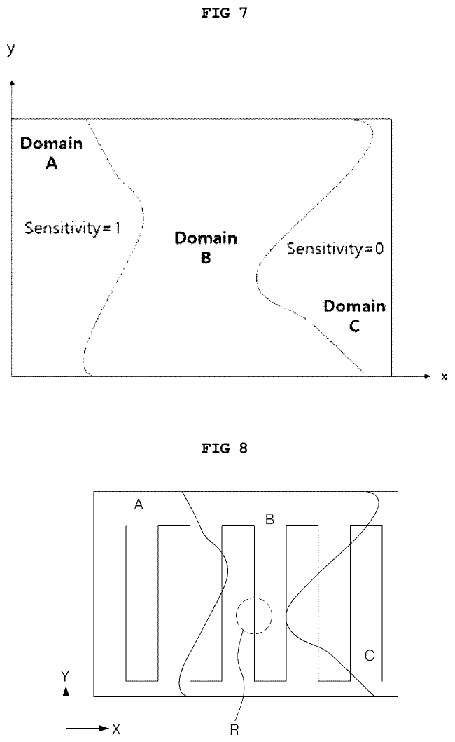

As shown in FIG. 7, numerical analysis shows that there are two regions, Domain A with sensitivity 1 of objective function and Domain B with sensitivity 0 of objective function, and a transition region, Domain B, may exist between these regions. If sensitivity map as shown in FIG. 7 is derived, basic material set by additive process can be placed in Domain C with sensitivity 0, and optimal material derived from material database can be placed in Domain 1 with sensitivity 1 to effectively control properties of the product. At this time, material setting of the transition region Domain B between two regions can be supplied by setting proportion of materials used in two regions according to the setting algorithm, and the control of material supply can be performed in stacking control step S70 to be described later. As will be described later, a method in which a ratio of heterogeneous materials gradually materializes through gradient material through material mixing or randomly arranges various materials may be employed in stacking control step S70.

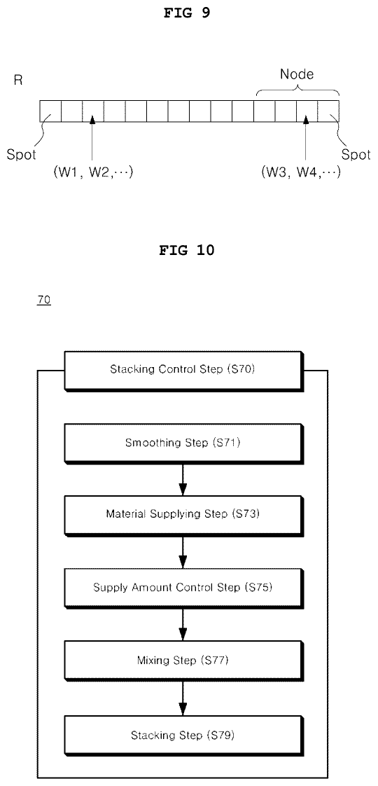

Referring to FIGS. 8 and 9, the mapping step S57 is a process of mapping sensitivity of material onto the 3D image data or toolpath, preferably by mapping sensitivity defined by coordinates to spots in the 3D image data or toolpath corresponding to the coordinates. That is, sensitivity at corresponding coordinate value is applied to coordinate value of 3D image data or toolpath. When the sensitivity region shown in FIG. 7 is applied to a toolpath, a toolpath can be derived with sensitivity applied or mapped as shown in FIG. 8. In this case, sensitivity value may be stored at coordinates of each toolpath.

In an embodiment shown in FIG. 9, which is an enlargement of the R part of FIG. 8, the mapping step S57 may store at least one or more material mixing ratios in the spots according to mapped sensitivity. At this moment, each spot represents a unit coordinate value in a 3D image, and mixing ratio of material may be stored in coordinate value of spot in forms such as (w1, w2, . . . ), (w3, w4, . . . ). Hereat, w1 and w3 are mixing ratios of first material, w2 and w4 are mixing ratios of second material, and if three or more materials are mixed, mixing ratios of third or more materials can also be stored. Accordingly, this simplifies additive process by storing material mixing ratios based on sensitivity in a single toolpath, rather than having multiple toolpaths for each material to be used.

In an embodiment, the mapping step S57 may define a predetermined number of consecutive spots on toolpath as nodes, and store a material mix ratio calculated from material mix ratios of the spots in the nodes. Material mix ratios of spots can be averaged and stored as overall material mix ratio for node.

Furthermore, in an embodiment of the present disclosure, sensitivity can be mapped only within a transition region with sensitivity values within a predetermined range. In other words, by excluding mixing of heterogeneous first and second materials in Domain C using base material set by the additive process, and Domain A using optimal material derived from material database, and storing mixing ratio to be different in transition region Domain B between two zones, amount of resources used for toolpath analysis and material supply can be reduced.

Referring back to FIGS. 2 and 10, the stacking control step S70 is a process of additive manufacturing by supplying and mixing heterogeneous materials and in a process of performing additive process in 3D printer 20, additive process may be controlled according to control data of controller 10. The stacking control step S70 includes a smoothing step S71, a material supplying step S73, a supply amount control step S75, a mixing step S77, and an additive manufacturing step S79. The supply amount control step S75, mixing step S77, and additive manufacturing step S79 may be performed by control data of controller 10 in real-time while the material supply step S73 is being performed. In other words, material is supplied at the material supply step S73 while amount of material is controlled, and mixing and additive manufacturing process is performed simultaneously, enabling a continuous additive manufacturing process.

The smoothing step S71 is a process of smoothing sensitivity, and sets supply change cycle in supply amount control step S73 to be described later, and calculates and smoothes sensitivity of a predetermined number of consecutive spots on toolpath according to supply change cycle. In supply amount control step S73, supply amount of material per unit time is controlled by controlling the speed of motor as described above and controlling degree of opening and closing of material supply part 21. In the present disclosure, sensitivity and mixing ratio of materials are changed for spot of toolpath, that is, toolpath and/or coordinate of 3D image data, rather than using different materials or varying mixing ratio of materials for each toolpath. If the supply amount varies according to sensitivity and mixing ratio of materials that changes for each coordinate, it is impossible to control or too much control data is required according to additive speed. Thus, the smoothing step S71 smoothes sensitivity of a predetermined number of consecutive spots according to supply change cycle set as shown in FIG. 9 through methods such as average calculation, and controls supply of heterogeneous materials according to smoothed mixing ratio and sensitivity.

The material supply step S73 is a process of supplying multiple materials toward nozzle 25, and may be performed by supply command from controller 10.

The supply amount control step S75 is a process of controlling supply amount of the material according to the sensitivity applied to 3D image data or toolpath, which may control supply amount of material according to speed of additive process, or control supply amount of multiple materials according to mapped sensitivity and mixing ratio of materials. The supply amount control step S75 may designate a predetermined range of sensitivities in the 3D image data or toolpath where sensitivities are mapped, and then supply at least one first material in a sensitivity region Domain C below predetermined range, at least one second material in a sensitivity region Domain A above predetermined range, and a mixture of first and second materials in a sensitivity region Domain B within the predetermined range, and may supply first and second materials in different mixing ratios in sensitivity region (Domain B) within predetermined range. The first and second materials may be single metal powder material, but may also be a composite of materials with different physical properties at the time of storage in material supply part 21.

Furthermore, in supply amount control step S75, a third material may be additionally supplied in transition region Domain B according to desired property, where third material may be a material having a physical property value between property values of first and second material that affects objective function. In this case, third material can be a non-metallic material for the purpose of imparting physical properties, and in an embodiment, if solubility between first and second materials is low, a material having good solubility with first and second materials can be used to function as an interlayer between first and second materials. In addition, as described above, third material may be mixed even if multiple objective functions are designated and numerical analysis is performed. When multiple objective functions are designated, second material may be suitable for a given objective, but second material may not be suitable for objectives for other properties, so third material may be mixed for areas with high sensitivity to other objective functions. In other words, it is understood by a person having ordinary skill in the art that the present disclosure allows for mixing of a fourth and fifth material in addition to third material.

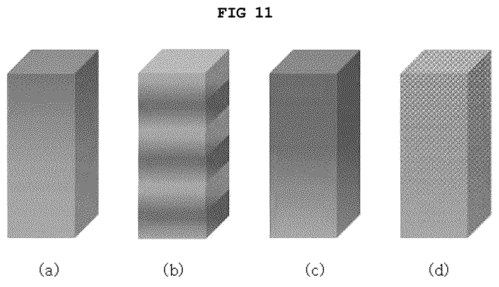

The mixing step S77 is a process of mixing multiple materials supplied from material supply part, and in an embodiment of the present disclosure, multiple materials supplied in powder phase can be mixed through an airflow and/or atmosphere formed therein. As shown in FIG. 11, due to mixing in the mixing step S77, mixture of materials supplied to nozzle 25 may have a gradual change in proportion from first material alloy A to second material alloy B (a), or may have a gradient in which mixing of first and second materials in (a) of FIG. 11 is repeated multiple times (b). In addition, a third material can be added to strengthen physical properties of mixed material (c), and ceramic particles as a second material can be mixed between metal powder phases as a first material (d).

The stacking step S79 is a process of supplying and adding materials through nozzle 25, in which heterogeneous materials mixed in a predetermined mixing ratio according to sensitivity are added to exclude process defects and materialize targeted physical properties for the product.

The foregoing detailed description is for illustrative purposes only. In addition, the description provides an exemplary embodiment of the present disclosure, and the present disclosure may be used in other various combination, changes, and environments. That is, the present disclosure may be changed or modified within the scope of the present disclosure described herein, a range equivalent to the description, and/or within the knowledge or technology in the related art. The embodiments show an optimum state for achieving the spirit of the present disclosure, and various modifications required for specific applications and uses of the present disclosure are also possible. Therefore, the detailed description of the present disclosure is not intended to limit the present disclosure in the embodiment. In addition, the claims should be construed as including other embodiments.

1. A heterogeneous material input control method for additive manufacturing comprising:
a toolpath generating step slicing provided 3D image data into multiple slices and determining a movement path of a nozzle;
a sensitivity applying step deriving sensitivity of heterogeneous material related to objective function by numerical analysis and applying sensitivity to the 3D image data or toolpath; and
an additive process controlling step by supplying, mixing, and adding heterogeneous material.

2. A heterogeneous material input control method for additive manufacturing of claim 1, wherein the sensitivity applying step comprises an objective function designating step for determining an objective function according to an optimization goal of a physical property of a shape of 3D image data, a numerical analysis step for performing numerical analysis according to the objective function to derive sensitivity of material, and a mapping step for mapping sensitivity of material to the 3D image data or toolpath.

3. A heterogeneous material input control method for additive manufacturing of claim 2, wherein the mapping step maps sensitivity defined by coordinates to spots in the 3D image data or toolpath corresponding to the coordinates.

4. A heterogeneous material input control method of additive manufacturing of claim 3, wherein the mapping step stores at least one material mixing ratio in the spot according to mapped sensitivity.

5. A heterogeneous material input control method of additive manufacturing of claim 3, wherein the sensitivity applying step further comprises a step of determining a transition region to determine a region having a sensitivity that causes heterogeneous material to be used among sensitivities derived from numerical analysis, and the mapping step maps sensitivities within the transition region.

6. A heterogeneous material input control method of additive manufacturing of claim 3, wherein the stacking control step comprises:
a material supply step supplying multiple materials, a supply amount control step controlling supply amount of materials based on sensitivity applied to the 3D image data or toolpath;
a mixing step for mixing multiple materials; and
a stacking step for supplying and adding materials in a 3D printer.

7. A heterogeneous material input control method of additive manufacturing of claim 6, wherein the supply amount control step specifies a predetermined range of sensitivities within the 3D image data or toolpath with mapped sensitivities,
and causes the 3D printer to supply at least one first material at sensitivities below predetermined range, at least one second material at sensitivities above predetermined range, and a mixture of first material and second material at sensitivity regions within predetermined range.

8. A heterogeneous material input control method of additive manufacturing of claim 7, wherein the supply amount control step supplies first material and second material in different mixing ratios according to change in sensitivity within a predetermined range.

9. A heterogeneous material input control method of additive manufacturing of claim 7, wherein the supply amount control step further supplies at least one third material.

10. A heterogeneous material input control method of additive manufacturing of claim 7, wherein the stacking control step comprises a smoothing step for smoothing sensitivity prior to the supply amount control step, and
the smoothing step sets a supply amount change cycle of the supply amount control step, and calculates and smoothes sensitivity of a predetermined number of consecutive spots on toolpath according to supply amount change cycle.

11. A heterogeneous material input control method of additive manufacturing of claim 7, wherein multiple materials are supplied in powder form in the material supply step, and powder is mixed through an airflow formed inside the 3D printer in the mixing step.

12. A heterogeneous material input control method of additive manufacturing of claim 4, wherein the mapping step defines a predetermined number of consecutive spots on toolpath as nodes, and stores material mixing ratio calculated from material mixing ratios of the spots at the nodes.

13. A heterogeneous material input control system of additive manufacturing, comprising:
a 3D printer processing additive manufacturing by spraying at least one material through a nozzle and then heating and disposing it to a surface; and
a controller receiving 3D image data and controlling supply of at least one material provided through the 3D printer;
the 3D printer comprising:
at least one material supply part for storing and supplying powder to be sprayed for additive manufacturing;
a mixing part for mixing material supplied from the material supply part;
a nozzle coupled to one side of the 3D printer for dispensing mixed material onto a surface; and
a heating part for heating material dispensed onto surface through nozzle to form it into a molten state;
the controller comprising:
a toolpath generation part slicing provided 3D image data into multiple slices and determining a movement path of a nozzle;
a numerical analysis part deriving sensitivity of heterogeneous material to an objective function through numerical analysis and applying it to the 3D image data or toolpath; and
a supply control part controlling supply speed and supply amount of the material in the 3D printer through a powder supply command;
the supply control part controlling supply amount of material so that heterogeneous material is mixed according to sensitivity of heterogeneous material to objective function mapped to toolpath.

14. A heterogeneous material input control system of additive manufacturing of claim 13, wherein the supply control part specifies a predetermined range of sensitivities within the 3D image data or toolpath with mapped sensitivities, and causes the 3D printer to supply at least one first material at sensitivities below predetermined range, at least one second material at sensitivities above predetermined range, and a mixture of first material and second material at sensitivity regions within predetermined range.

15. A heterogeneous material input control system of additive manufacturing of claim 14, wherein the supply control part sets a supply amount change cycle of material supplied from material supply part of the 3D printer, and controls supplying amount of material after smoothing by calculating sensitivity of a predetermined number of consecutive spots on toolpath according to supplying amount change cycle.
